(19) United States
(12) Patent Application Publication
(10) Pub. No.: US 2006/0150872 A1
(43) Pub. Date: Jul. 13, 2006

(54) Security checking cabin and method

(76) Inventor: Joshua Mesinger, Haifa (IL)

Correspondence Address: LOWE HAUPTMAN BERNER, LLP, 1700 DIAGONAL ROAD, SUITE 300, ALEXANDRIA, VA, 22314, US

(21) Appl. No.: 11/373,267

(22) Filed: Mar. 13, 2006

Related U.S. Application Data
(63) Continuation-in-part of application No. PCT/IL04/00837, filed on Sep. 12, 2004.

(30) Foreign Application Priority Data
Jul. 6, 2005 (IL) 169548
Sep. 12, 2003 (IL) 157900

(51) Int. Cl. E05G 5/00

(52) U.S. Cl. 109/8

(57) ABSTRACT

A secured checking cabin for checking people entering closed public regions has an entrance passage between two armored walls defining a gap dimensioned to prevent more than a single person at a time to walk between the walls side by side. At least one armored capturing unit coupled to the entrance passage admits a person coming from the entrance passage, and is in communication with a closed public space. An entrance mechanism allows the entrance of one person at a time to the entrance passage, and a no-return mechanism prevents him from returning therethrough. An exit mechanism releases a person from the capturing unit to the closed public space, and a locking mechanism locks both the entrance and exit mechanisms upon demand. At least one detector is located in the entrance passage or in the capturing unit for detecting a material suggestive of a potential danger.

### RELATED APPLICATIONS

The present application is a continuation-in-part of PCT/IL2004/000837, which was filed Sep. 12, 2004 and claims Convention Priority from IL 157900 dated Sep. 12, 2003. The present application also claims Convention Priority from IL 169548 filed Jul. 6, 2005.

### FIELD OF THE INVENTION

The present invention relates to the field of public security. More specifically it relates to the field of defending civilians from terrorists who wear or carry explosive charges or weapons.

### BACKGROUND OF THE INVENTION

During the period of the last few years there has been a significant worldwide increase in terror attacks involving suicide terrorists who carry explosive charges on their own body to blow themselves up in the middle of a crowd of civilians. The bitter short history in this field shows (and self-evidently conforms with the physical predictions) that the most murderous effects of such terror attacks occur inside closed crowded spaces, such as airplanes, passenger buses, pubs, restaurants, lobby halls, and the like. In such closed places the blast effect of explosives is extreme and exhaustive, since most of their discharged energy remains in the closed area causing extreme blast and strike damages before it may burst a way out.

Current known methods for increasing public security in this field are based on security personnel positioned at the entrances and exits of public spaces, for checking every person who wishes to enter. Such checking generally includes one or more of the following (depending on the individual intuition of the security guards and on their instructions): visual inspection, verbal questioning, ID certification, metal detector scanning, or scanning by other sensor and inspection instrumentation as well. These known methods may reduce the chance of a terrorist to enter into closed places, however, several security guards have unfortunately paid with their own lives and with the lives of others, while trying to prevent suicide terrorists from entering.

It would therefore clearly be an advantage if the required checks were implemented without the need for security guards to subject civilians to checking procedures.

### SUMMARY OF THE INVENTION

It is therefore an object of the invention to provide a method and apparatus for allowing security checks to be implemented without the need for security guards to subject civilians to checking procedures.

This object is realized in accordance with a first broad aspect of the invention by a secured checking cabin for checking people entering closed public regions, the checking cabin comprising:

an entrance passage defining a gap between two armored walls, the gap being dimensioned to prevent more than a single person at a time to walk between said walls side by side;

at least one armored capturing unit coupled to the entrance passage for receiving a person coming from the entrance passage, and being in communication with a closed public space;

an entrance mechanism for allowing the entrance of one person at a time to the entrance passage;

a no-return mechanism for preventing a person from returning back from the entrance passage;

an exit mechanism for releasing a person from the capturing unit to the closed public space;

a locking mechanism for locking both said entrance and exit mechanisms upon demand; and

at least one detector located in the entrance passage or in the capturing unit and being capable of detecting a presence of material suggestive of a potential danger.

The detector(s) may be of any known suitable kind, including chemical sensors for detecting and identifying substances of interest in the surroundings and/or identifying by IR imaging certain objects that might be carried by the person, e.g., explosives.

The present invention also preferably provides a metal detection unit accommodated in association with the cabin The detection unit is configured to be sensitive to small metal objects such as knives bullets and the like, and is associated with a conveyor for receiving small personal objects of a person to be checked and for conveying them to meet their owner after he was checked by the unit, without influencing his checking.

In accordance with a second broad aspect of the invention, there is provided a method for checking people entering closed public region, the method comprising:
(a) admitting people to a closed region one by one via an entrance passage to an exit passage;
(b) detecting for suspected hazardous material associated with each person during his progress between the entrance passage and the exit passage;
(c) if suspected hazardous material is detected on a suspect:
   i) constraining the suspect to enter an armored capturing unit;
   ii) preventing the suspect from exiting and preventing others from entering the armored capturing unit;
   iii) subjecting the suspect to further checks and, if deemed necessary, neutralizing the suspect; and
(d) preventing people from exiting from the exit passage unless no hazardous material is detected or until suspected hazardous material is neutralized.

In the context of the present invention the term “armored” when relating to a wall or to a barrier, implies that the wall (or barrier) is of a construction and material capable of withstanding an explosion of at least 0.5 Kg explosive substance in close proximity to an internal surface thereof, without permeating to the outer surface of the wall or barrier. It will be appreciated that the walls of the device may or may not be of the same strength, e.g. the walls of the capturing unit may be better reinforced to withstand explosion than the parallel walls forming the entrance or exit passages. The armored wall can be of any material or combination of materials, in any suitable reinforcement construction, known in the art as withstanding explosion, and/or blasts. Layers of such materials may be used as well. The wall or portions of it may be part of an existing infrastructure, or may consist in part of portions of such an existing infrastructure (i.e. existing already in the site to be defended).

According to one preferred embodiment the wall of the capturing unit is constructed of reinforced concrete containing about 200 Kg steel (or iron) per cubic meter of concrete, and being about 0.3 meter in thickness. Preferably there is further provided in the wall (either on or under the concrete) a reinforcement belt located in the wall at a height matching the height in which an explosive charge is mostly expected or is usually carried on terrorist's body (e.g. between 100 cm and 200 cm above the floor). Such a reinforcement belt can be made for example from at least one steel plate of a thickness between 8 and 15 millimeter. In case the wall is curved the plate is provided with a corresponding curve.

The secured checking cabin according to this invention may further comprise an armored ceiling. However according to various embodiments of the device the cabin may have an open top, a partially open top, or a top covered with soft and light material e.g. a water resistant cloth which may protect from rain, while causing no damage in case of explosion inside the cabin. Other types of soft or light covering may used as well. This is in order to direct at least a portion of possible blast and splinters to be released in a direction where no person is expected or positioned, i.e. upwards. There may be designed in the cabin other openings, in different locations than in its top, for the same purpose of releasing blasts. However, such openings should be terminated with appropriate channeling directing the blast to a place where no person is positioned or expected. According to one embodiment the entrance passage is bent at least once along its path, e.g. at an angle of 90°, such that there is no straight trajectory between the capturing unit and between the distant end of the two parallel walls.

In its various embodiments the cabin according to the present invention (or any part of the cabin) further comprises an integral armored floor. However, when applicable, the existing floor upon which the cabin is positioned in the site to be defended, may be used as the floor of the cabin itself, which should, however, be effectively anchored to the existing infrastructure, prior to use.

According to various embodiments of the present invention the entrance and exit mechanisms make use of a common construction. According to some of these embodiments, the capturing unit is made of two semi-cylindrical barriers each being a continuation of a respective one of the two armored walls of the entrance passage. A carousel of a carousel-type gate is positioned between the two semi-cylindrical barriers, and is rotatable about a vertical axis placed at substantially the middle between the barriers. According to this embodiment, the carousel-type gate fulfills several functions (however not all the functions have to be utilized): it serves as the entrance mechanism allowing the entrance of one person at a time from the entrance passage to the capturing unit and as a no-return mechanism preventing his return; it also serves as the exit mechanism allowing the exit of the person from the capturing unit; and it further serves as the locking mechanism allowing for simultaneous lock of both said entrance and exit mechanisms. Thus, a person who enters through the entrance passage, may not continue passing to the defended public region (which requires a respective rotation of the carousel, that is prohibited) until he has been checked and found safe to enter. Preferably the at least one sensor for detecting potentially hazardous materials such as metals or explosives is located in the entrance passage. The carousel can freely rotate allowing everyone to enter the public space, unless becoming locked upon positive detection by at least one detector and after the person whose detection was positive has reached a position between two angularly spaced barriers of the carousel and between an armored wall of the capturing unit. According to some embodiments however, the capturing unit itself is equipped with detectors, either for confirming the result of the detection made in the entrance passage, or for additional check, or even for initial check in embodiments where there are no detectors in the entrance passage, or in case the detectors in the entrance passage are not in working condition for some reason. The detection in the capturing unit is effected when both entrance and exit mechanisms are in their locked state, i.e. when the carousel is locked and the detected person is captured between two angularly spaced barriers of the carousel and an armored wall of the capturing unit. In such a case, the lock is released only upon negative detection. According to various embodiments of the present invention and in order to minimize delays in the detection of masses of people, the secured checking cabin may further comprise a secondary checking unit communicating with the entrance passage, with the capturing unit, or with the exit passage through a lockable door or gate (which according to some embodiments may be the carousel gate itself, as will be explained later). Upon a positive detection and, according to some embodiments upon a partially positive detection (e.g. when the detection is positive to the presence of metals but is negative to the presence of explosives), the person to whom the detection relates is directed to the secondary checking unit, while his way to the defended region becomes locked. During checking by the secondary checking unit, additional persons may be checked and released to the defended region through the capturing unit, without disturbing the line as a result of said positive or partial positive detection. In order to expedite the checking process the device may comprise several secondary checking units. According to various embodiments of the invention, the secondary checking units may serve for capturing as well, and can be made of armored walls and have one or more armored doors.

According to various embodiments of the present invention the checking cabin further comprises an intercom allowing communication with a person captured inside the capturing unit or inside the secondary checking unit. Furthermore it may comprise at least one video camera allowing inspection inside the passage, the capturing unit, or the secondary checking unit.

In some embodiments, the capturing unit or the secondary checking unit comprise (in their walls, or in their doors if present) an armored inspection window or eyepiece allowing inspection inside the cabin. The entire cabin walls (and or doors if present) can be made of a transparent material that withstands an explosive blast.

In the preferred embodiment there is also a warning siren actuated upon recognition of explosive material or metal inside the cabin. The operation of the siren may be automatic upon machine recognition of explosives or metals, or may require operator involvement, all according to predetermined user preferences input to a controller of the cabin.

According to the preferred embodiments the cabin has overcoming means for overcoming a suspected person, neutralizing him, or preventing his freedom to act. Such means may be one or more from the following: electrical or chemical shocker adapted to shock a suspected person inside the cabin; electrical or chemical shocker adapted (e.g. in their location at the cabin exterior) to shock a suspected person near and outside the cabin; sedating gas releasing device; remote controlled handcuffs; auto latch handcuffs.

A cabin according to the present invention may further comprise means for confirming explosive detection by exploding the recognized explosive charge for neutralizing the charge thereby avoiding risk to civilains and security personnel. Such means may be operated manually, after communicating with a suspected person through the intercom, commanding him to undress the charge from his body and put it in an appropriate exploding cell or hole prepared for that purpose inside the cabin (e.g. under cabin's floor), commanding him to lock his hands with the handcuffs and exit the cabin, before exploding the charge. Such means may however be designed to operate automatically upon recognition of an explosive charge, and after a failure to communicate with the suspected person, if so desired. In such a case a warning announcement is generated to move civilians away from the cabin, and a timer may then effect delayed ignition of an igniter adapted to trigger an explosion of explosives inside the cabin. Such igniter may comprise one or more of the following: chemical reactor injection means, high intensity light beam generator, microwave transducer, ultrasonic transducer, electric spark generator, detonator shooting device.

The igniter may be a directional unit, or a plurality of units, arranged for covering the volume of the cabin (or of an exploding cell or hole, if one exists), either in a predetermined array or by scanning the volume (e.g. by means of a vibrating beam deflector).

The cabin of the present invention may be permanently secured to a fixed construction near the entrance of a closed public region. Furthermore, according to various embodiments it is constructed as a standalone mobile unit and further having anchoring means allowing it to be secured at the site to be defended. However, according to other embodiments it may be constructed as an immovable unit at a site to be defended.

According to additional embodiments, the cabin has a rectangular shape, and the entrance and exit mechanisms are constituted by separate doors in the cabin for opening and closing the capturing unit to the entrance passage and to the protected public space, respectively. Such doors may be sliding doors that slide laterally. However, in order to allow minimum wall length (to enable using the cabin in places restricted in space), the doors may be designed to slide vertically. According to this arrangement, the cabin may be very tall, i.e. having a height that is twice as high as a door, thereby directing possible blasts and splinters out of harmful range. This is especially useful when the cabin has no ceiling, which might itself absorb the blast and splinters. In embodiments having a sliding or a hinged door arrangement there is preferably a security mechanism allowing only one door at a time to be open, thus preventing free passage via the cabin. The door leading to the protected public space is opened only after the person being checked is cleared of risk. This security mechanism is part of the locking mechanism which locks both doors upon detection of metals or explosives.

The present invention further relates to a method for preventing armed terrorists from entering closed public spaces, the method comprising: admitting individuals into a closed space one by one, by directing each person through an entrance passage having at least one detector capable of sensing explosives or metals carried on the person; the entrance passage leading the person into a capturing unit of a secured cabin, having entrance and exit mechanisms; locking the entrance and exit mechanisms after the person has entered the capturing unit and upon positive detection by the at least one detector. Alternatively the exit from the capturing unit to the protected public region may be opened upon negative detection of explosives or metals on a currently checked person.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 illustrates a top overview of a secured checking cabin according to an exemplary embodiment of the present invention.

FIG. 2 illustrates a top view of alternative embodiment of the rotating member of the carousel illustrated in FIG. 1.

FIG. 3 illustrates another embodiment of a secured checking cabin according to an exemplary embodiment of the present invention.

### DETAILED DESCRIPTION OF EXEMPLARY EMBODIMENTS

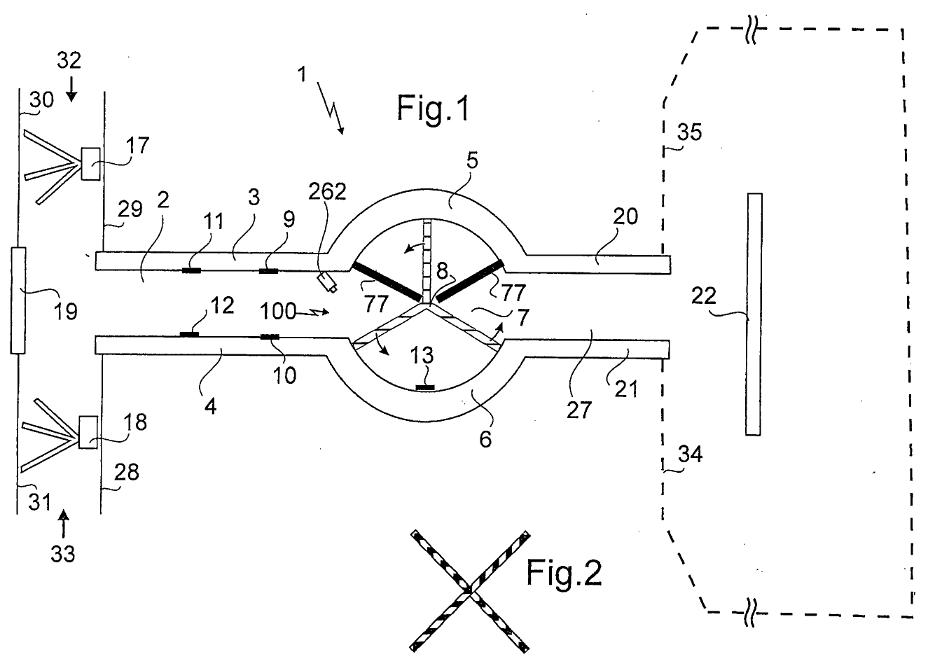

FIG. 1 illustrates a top overview of a secured checking cabin 1 in the form of a passageway comprising an entrance passage 2 being a gap between two armored walls 3 and 4 (which might be substantially parallel). Preferably the gap is dimensioned to permit a single person at a time walking among the walls. Circular wall sections 5 and 6 adjoin the walls 3 and 4, respectively, at a first end of the wall sections 5 and 6 near the entrance passage 2, a second end of the circular wall sections 5 and 6 adjoining wall sections 20 and 21, respectively remote from the entrance passage 2. The far end of the wall sections 20 and 21 abut fences 34 and 35, respectively, which define portions of a border of a closed public region remote from the entrance passage 2. A wall section 22 that is normal to an axis of the entrance passage 2 and is parallel to the fences 34 and 35 protects the public region from possible explosion in the secured checking cabin.

The circular wall sections 5 and 6 are armored so as to form an armored capturing unit 100 (also referred to as a main capturing unit) for receiving a person coming from the entrance passage 2 and dismissing him via an exit passage 27 to the closed public region. The cabin also includes an entrance mechanism for allowing the entrance of one person at a time to the entrance passage, a no-return mechanism for preventing a person from returning back from the entrance passage, and an exit mechanism for releasing a person from the capturing unit to the closed public space. In the present example, these mechanisms are implemented by providing the armored capturing unit 100 with a carousel 7 that rotates in one direction only about a vertical axis 8 for allowing the entrance of one person at a time from the entrance passage 2 to the capturing unit 100, while preventing his return. Radially disposed blocking rods 77 disposed within the circular wall sections 5 and 6 are aligned with slots in the carousel 7 so as to allow unimpeded rotation of the carousel 7 while preventing entry to the carousel 7 from the closed public region. Detectors 9 and 10 are disposed on opposite sides of the passage 2 on the wall 3 and 4, respectively. Likewise, detectors 11 and 12 are disposed on opposite sides of the passage 2 on the wall 3 and 4, respectively. One of the detectors 9 and 11 is adapted to detect metal while the other is adapted to detect explosives; the same applying to the opposite detectors 10 and 12. Disposed within the carousel 7 on an inside surface of the circular wall section 6 is a detector 13 that is adapted to detect explosives. The carousel 7 thus constrains a person to enter the armored capturing unit 100 from the entrance passage 2 in such a direction that he passes the detector 13 before exiting to the closed public region from which he is unable to pass back though the carousel 7 to the entrance passage 2.

The present invention does not limit it scope to the illustrated configuration of detectors, and thus the type, number and positions of detectors in the cabin may be changed by those skilled in the art without departing from the scope of the present invention. The invention also allows use of a dog trained in recognizing explosives is located in a hut which is in gas communication with the entrance passage 2, e.g. through a pipe connected to appropriate hole in the wall 3 or 4, or with the capturing unit 100 e.g. through pipe passing from above the wall for suctioning air from the checking cabin to the hut. The responses of the dog may be monitored automatically and/or by human personnel such that upon recognition of explosive by the dog the carousel will be locked through a procedure similar to that performed upon positive detection by the detectors 9, 10, 11, 12, 13, or by any other detector existing in the cabin.

According to the illustrated embodiment the public to be detected is arranged in two queue lines for entering the checking cabin from the directions indicated by arrows 32 and 33. Turnstiles 17 and 18 operate correspondingly to allow people to pass one at a time to the entrance passage 2. After each person passes either one of the turnstiles 17 and 18, both gates 17 and 18 are locked until the person has exited from the capturing unit 100 to the exit passage 27. The position of such person is communicated to a controller (not shown) of the secured cabin according to the activity of the carousel 7, and/or according to sensors (e.g. photo cells) located along the cabin for this purpose. For example, when a person enters the capturing unit 100, the controller allows a 120° counterclockwise rotation of the carousel, whereupon the person advances through the carousel 7 such that he is located between circular wall section 6 and two proximal angularly spaced barriers of the carousel 7. The controller is informed of such rotation of the carousel (e.g. by means of a micro-switch or photocell, which sends a signal to the controller upon sensing the edge of an angularly spaced barrier of the carousel passing in its closed proximity), and can thus determine the location of the person. If no metal or explosive is detected by the relevant detectors, the controller enables another 120° rotation of the carousel thereby allowing the person to enter the defended public region.

Means may be disposed within the capturing unit 100 for exploding the a detected explosive charge in order to eliminate the need to risk humans for neutralizing the charge. Such means may be operated manually, after communicating with a suspected person through an intercom 261, commanding him to remove the charge from his body and put it in an exploding cell prepared for that purpose underneath the floor, commanding him to lock his hands with handcuffs, and allowing him to exit the cabin, before exploding the charge. The person's responses and behavior may be monitored by a video camera 262. Such means for confirming explosive detection by exploding the charge may however be designed to operate automatically upon recognition of explosive charge, and after a failure to communicate with the suspected person, if so desired. In such a case a warning is generated e.g. by activating a siren or a blinking light device to warn the crowd to withdraw. A timer that is a part of the controller may then handle the operation of igniter units adapted to trigger an explosion of explosives inside the cabin. Such igniter may comprise one or more of the following: chemical reactor injection means, high intensity light beam generator, microwave transducer, ultrasonic transducer, electric spark generator, detonator shooting device. The cabin may further comprise electrical or chemical shocker devices to allow shocking a suspected person. The same shocker devices may be added also to the exterior of the cabin walls, near its entrance, thus allowing subjecting a suspected person to an electrical shock near and outside the cabin (i.e. before he enters the cabin). The cabin may further comprise a sedating gas releasing device (not shown) for causing a suspected person to become drowsy or insensible. Such device may be located inside a housing for circulating the gas inside the cabin (using the same infrastructure that uses for suctioning air from the capturing unit).

The handcuffs may be manually operated auto latch handcuffs, or remote controlled handcuffs, activated through the controller either for latching, or releasing hands, and/or for releasing the handcuffs from the cabin wall, in order to allow the suspected person walk out the cabin with tied hands.

FIG. 2 illustrates a top view of an alternative embodiment of the rotating member of the carousel illustrated in FIG. 1. The same description of FIG. 1 applies mutatis mutandis, i.e. since the carousel of FIG. 2 comprises four angularly spaced barriers instead of the three of FIG. 1, whenever the description of FIG. 1 refers to a 120° rotation, a 90° rotation applies when using the embodiment of FIG. 2.

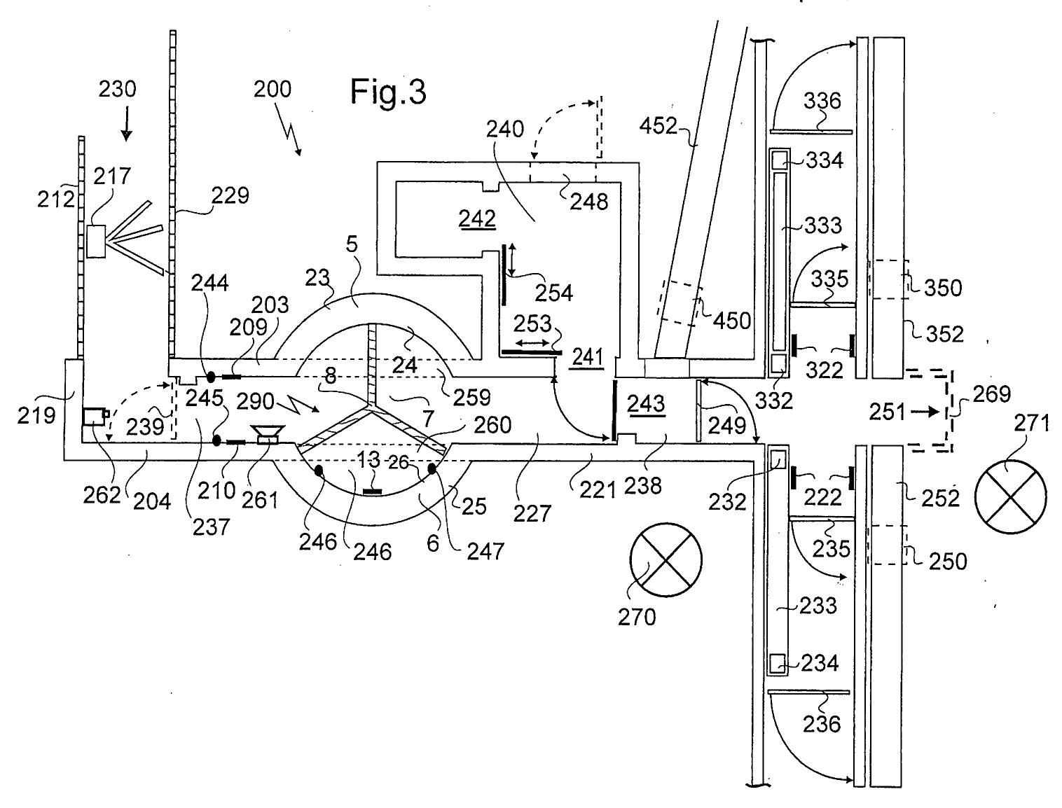

FIG. 3 illustrates another embodiment of a secured checking cabin 200 according to the present invention. In this embodiment there is provided a secondary capturing unit 240, useful for carrying out an extended check of a suspected person, while others continue to be checked in the main capturing unit 290 without interruption. People to be checked are queued prior to entry to the entrance passage 237 in a line in the direction indicated by arrow 230, in the gap bound by fences 212 and 229, which abut opposite sides of the entrance passage 237. The first in the line stands before the turnstile 217 and waits until passage through the turnstile is allowed, this being notified by a buzzer or a beep activated automatically by the controller upon exit of the person currently being checked (which can be recognized automatically e.g. by a photocell located in the exit passage 238). The first in the line then walks through the turnstile (and optionally through a door 239 that may be provided as will be explained later) to the entrance passage 237 between the armored walls 203 and 204. During his walk in the entrance passage he is checked by smell detectors 244, 245, and by metal detectors 209, 210, whereafter he enters the capturing unit 290 by moving the carousel 7 counterclockwise about its central axis 8. In case there was a positive detection by any of the detectors in the entrance passage, the carousel will automatically lock so as capture the person between two angularly spaced barriers of the carousel. In such circumstances an additional check can be performed by the smell detectors 246, 247, and by the metal detector 13. If provided, the optional door 239 can pivot automatically to separate between the civilians in the line and the suspect. A guard may speak with the suspect through the intercom 261, and ask him to remove the object responsible for the positive detection, and to place it e.g. in a special cell under the floor or in the wall. If the person is unwilling to cooperate, the guard may stun him or sedate him automatically by any stunning or sedation means know in the art, that may be prepared in advance in the capturing unit for remote activation. In the worse scenario of explosion the armored walls of the checking cabin will protect the civilians and the guards from harm. Since the cabin has no roof (or at most has a light weight roof) the blast of explosion will be released upwardly, and the end walls 219 and 269 will protect from splinters flying from the focus of explosion in the capturing unit.

In the case where the suspect cooperates and the guard finds it safe enough to make a physical check on its body he may unlock the carousel, allowing the person to enter the secondary capturing unit 240 for a physical check or questioning. Alternatively, the guard may release the suspect allowing him to reach the exit passage 238, by opening the door 243. Under normal conditions, door 243 may be positioned so as to block the passage 241, allowing checked people to walk from the entrance passage 237 to the exit passage 238 through the capturing unit with the carousel freely rotating (unless a positive detection has been made by any of the detectors 244, 245, 209, 210, 246, 247, and 13, resulting in locking the carousel). By means of such an arrangement, the checking procedure of a large crowd may flow smoothly. In the case where a positive detection occurs, the suspect may be directed to the secondary capturing unit 240, thereafter the door 241 may be closed by either the sliding door 253 or the pivot door 243, after which checking of successive people in the queue may continue. After checking and questioning, the suspect may be released from the secondary capturing unit 240, either through the optional door 248 if one exists, or by temporarily stopping the flow of people into the checking cabin, and returning the person from the secondary capturing unit 240, back through the door 241, to exit through door 243 and the exit passage 238.

Optionally and according to various embodiments of the present invention, every person that reaches the exit passage 238 is requested to deliver his hand luggage on a conveyor e.g. 452, for an X-ray examination by an X-ray device 450, before he may open the door 249. After passing the door 249 the person, optionally and according to various embodiments of the present invention, continues to be examined while proceeding through a final detection path. The final detection path includes a metal detector gate 322, which is designed to respond more sensitively than the metal detectors 209, 210 of the entrance passage 237. In order to be allowed to pass through the door 335, the metal detection has to respond negatively, and for this purpose the checked person has first to remove small metal objects such as keys, watch, mobile phone or the like, and put them on conveyer 333 through opening 332. After removing such metal objects the person may pass the metal detector 322, and the door 335 can then be opened. When the door is opened the small objects being conveyed by the conveyer 333 from the opening 332 are protected from above by a transparent plate. The content of the small objects is thus visible to a guard in the guard tower 271 (either directly or through a camera and monitor system) or the guard tower 270, and in case a suspected object is identified (e.g. a small pistol, a knife, etc.), the guard may halt the conveyer before the object reaches the outlet opening 334 of the conveyer 333. In the case that the conveyor is halted by a guard, the person is captured between the doors 335 and 336, until reached by guards for further treatment. Under normal conditions the door 336 can be opened and the person can pass through and enter the protected region only after removing his small objects from the conveyer through the outlet opening 334. This can be recognized automatically e.g. by a load cell that weighs the load on the conveyer, or e.g. by photocells which detect interruptions in a light beam scanning the conveyer. This ensures that such objects will not be forgotten by their owners. Another final detection path is provided opposite to the first one and includes a metal detector gate 222, doors 235 and 236 and conveyor 233, such that the crowd checking may flow smoothly even if there is a delay in one of the final detection paths. Additional final detection paths may be located in parallel to the first ones by extending the corridor in the direction indicated by arrow 251. Furthermore, such final detection paths may include also X-ray detection conveyers 352, 252 having respective X-ray devices 350, 250 (either additionally or as a substitute to the X-ray conveyer 452). Another alternative is to locate the starting end of the conveyor X-ray 452 at or near the wall 203, so as to permit hand luggage to be deposited immediately at the beginning of the checking procedure.

According to another variation of the illustrated embodiment, neither the capturing unit nor the carousel is provided. Instead, the walls 203 and 204 of the entrance passage continue straight as illustrated by dotted lines 259, 260. According to this variation, the only capturing unit is the secondary capturing unit 240. After a person enters through door 239, it becomes locked to prevent his return, and so is the door 243 and the sliding door 253. If the detection of the person is confirmed to be negative according to the signals supplied to the controller by detectors 244, 245, 209, and 210, the door 243 is opened and the person is allowed to continue as described by the description of the main embodiment. If the detection is positive, the sliding door 253 is opened and the suspected person is guided by the intercom 261 to enter the capturing unit 240 through door openings 241 and 242 for further treatment. The door openings 241 and 242 are then closed by the sliding doors 253 and 254 to capture the suspected person remotely from the conventional checking path between doors 239 and 243, such that the flow of the crowd to be checked may continue without further disturbs. It is appreciated that an additional capturing unit similar to 240 may be provided along the walls 259 or 260 if so required.

The secured checking cabin may further comprise detectors for recognizing contrabands, such as illegal drugs, and thus may facilitate and simplify the checking procedures of crowd e.g. in airport terminals, thus eliminating the need for additional separate checking procedures.

1. A secured checking cabin for use in checking people entering closed public regions, the checking cabin comprising:
an entrance passage defining a gap between two armored walls, the gap being dimensioned to prevent more than a single person at a time to walk between said walls side by side;
at least one armored capturing unit coupled to the entrance passage for receiving a person coming from the entrance passage, and being in communication with a closed public space;
an entrance mechanism for allowing the entrance of one person at a time to the entrance passage;
a no-return mechanism for preventing a person from returning back from the entrance passage;
an exit mechanism for releasing a person from the capturing unit to the closed public space;
a locking mechanism for locking both said entrance and exit mechanisms upon demand; and
at least one detector located in the entrance passage or in the capturing unit and being capable of detecting a presence of material suggestive of a potential danger.

2. Secured checking cabin according to claim 1, wherein the wall of the capturing unit is constructed of reinforced concrete containing about 200 Kg steel or iron per cubic meter of concrete.

3. Secured checking cabin according to claim 1, wherein the wall of the capturing unit is constructed of reinforced concrete of about 0.3 meter thickness.

4. Secured checking cabin according to claim 1, further comprising at least one secondary capturing unit coupled to the entrance passage for receiving a person coming from the entrance passage, and being coupled to a closed public region for dismissing a person to the public region.

5. Secured checking cabin according to claim 1, further comprising at least one X-ray detection unit having a conveyor for conveying and checking hand luggage of a person being checked.

6. Secured checking cabin according to claim 1, wherein the at least one detector comprises a metal detector or a smell detector.

7. Secured checking cabin according to claim 1, wherein the locking mechanism comprises a lockable carousel gate.

8. Secured checking cabin according to claim 1, further comprising an armored ceiling.

9. Secured checking cabin according to claim 1, further comprising an armored floor.

10. Secured checking cabin according to claim 1, permanently secured to a fixed construction near the entrance of a closed public region.

11. Secured checking cabin according to claim 1, further comprising a warning siren adapted to be actuated upon recognition of explosive inside the cabin.

12. Secured checking cabin according to claim 1, further comprising overcoming means for overcoming a suspected person.

13. Secured checking cabin according to claim 12, wherein the overcoming means is adapted to shock the suspected person.

14. Secured checking cabin according to claim 12, wherein the overcoming means comprises an electrical or chemical shocker adapted to shock the suspected person.

15. Secured checking cabin according to claim 12, wherein the overcoming means comprises a sedating gas releasing device.

16. Secured checking cabin according to claim 1, further comprising an explosive igniter adapted to trigger an explosion of explosives inside the cabin.

17. Secured checking cabin according to claim 16, wherein the explosive igniter comprises at least one from the group of chemical reactor injection means, high intensity light beam generator, microwave transducer, ultrasonic transducer, electric spark generator, and detonator shooting device.

18. Secured checking cabin according to claim 1, constructed as a standalone mobile unit and having anchoring means for securing the secured checking cabin at a site to be defended.

19. Secured checking cabin according to claim 1, further comprising metal detection unit sensitive to small metal objects such as knives bullets and the like, and a conveyor for receiving small personal objects of a person to be checked and for conveying them to meet their owner after he was checked by the unit, without influencing his checking.

20. A method for checking people entering closed public region, the method comprising:
(a) admitting people to a closed region one by one via an entrance passage to an exit passage;
(b) detecting for suspected hazardous material associated with each person during his progress between the entrance passage and the exit passage;
(c) if suspected hazardous material is detected on a suspect:
i) constraining the suspect to enter an armored capturing unit;
ii) preventing the suspect from exiting and preventing others from entering the armored capturing unit;
iii) subjecting the suspect to further checks and, if deemed necessary, neutralizing the suspect; and
(d) preventing people from exiting from the exit passage unless no hazardous material is detected or until suspected hazardous material is neutralized.
